(19) United States
(12) Patent Application Publication
(10) Pub. No.: US 2016/0247192 A1
(43) Pub. Date: Aug. 25, 2016

(54) SYSTEMS AND METHODS FOR DYNAMIC CONTENT PRESENTATION

(71) Applicant: LessThan3, Inc., San Francisco, CA (US)

(72) Inventors: Ari Evans, San Francisco, CA (US); Bryant Williams, San Francisco, CA (US)

(73) Assignee: LessThan3, Inc.

(21) Appl. No.: 14/629,955

(22) Filed: Feb. 24, 2015

(51) Int. Cl. G06Q 30/02

(52) U.S. Cl. CPC G06Q 30/0255; G06Q 30/0269; G06Q 30/0277

(57) ABSTRACT

Content may be presented to users based on their navigation through online content. Users may access online content through a web page, website, application, and/or other sources. The online content may include streams of multimedia content which the users may browse through and/or otherwise navigate between. Interim content (e.g., ads and/or other content) may be associated with different navigation paths. The interim content may be dynamically presented to the user based on one or more of the users' current navigation path, a demographic profile associated with the user and/or interim content, and/or other information.

### FIELD OF THE DISCLOSURE

This disclosure relates to presenting interim content to users based on the paths they take to navigate online content.

### BACKGROUND

Online content may be expressed in a variety of ways. In some implementations, online content may be presented to users through a web page, website, application and/or other source hosted by one or more online content servers. Users may access the servers and/or the online content via client computing platforms. The client computing platforms may communicate with the one or more servers over a network, such as the Internet.

In some implementations, advertisements may be served to the users as they interact with the online content. Advertisements may be presented to users in a variety of ways. For example, advertisements may be served based on the amount of time a user spends viewing and/or interacting with online content. As another illustrative example, advertisement may be served based solely on the user clicking a link, and/or other considerations.

### SUMMARY

One or more aspects of the present invention relate to a system for dynamic content presentation to users based on user navigation paths through online content. The online content may include streams of multimedia content, and/or other considerations. The users may be presented interim content, such as advertisements and/or other considerations, as they navigate through the online content. The presentation of the interim content may correspond to not only a user's request to access a stream of multimedia content, but also may correspond to the particular stream the user may be currently accessing and therefore requesting to navigate away from. This navigation from one particular stream to another particular stream may be referred to as a path. The interim content may be associated with the different navigation paths such that by virtue of obtaining information that reflects the paths the users are currently navigating, associated interim content may be dynamically presented to the user.

The system may include one or more servers including one or more processors. The processor(s) may be configured to execute one or more computer program components to facilitate content presentation to users based on user navigation paths through online content. The computer program components may include one or more of an interim content component, a path information component, a presentation component, and/or other considerations.

The interim content component may be configured to associate interim content with paths. The paths may correspond to user navigation between different streams of multimedia content, and/or other content. By way of illustration, first interim content may be associated with a first path. The first path may correspond to user navigation from a first stream of multimedia content to a second stream of multimedia content.

The path information component may be configured to obtain path information that reflects the paths through which the users may be navigating between streams of multimedia content. The obtained path information may include first path information associated with a first user. By way of illustration, responsive to the first user currently viewing the first stream of multimedia content and requesting to view the second stream of multimedia content, the first path information may reflect that the first user may be currently navigating the first path.

The presentation component may be configured to effectuate presentation of interim content to the users based on their current navigation paths, and/or based on other information. By way of illustration, responsive to the first path information reflecting that the first user may be currently navigating the first path, presentation of the first interim content to the first user may be effectuated. In some implementations, the first interim content may be presented prior to presentation of the second stream of multimedia content.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular forms of “a”, “an”, and “the” include plural referents unless the context clearly dictates otherwise.

### BRIEF DESCRIPTION OF THE DRAWINGS

FIG. 1 illustrates a system for dynamic content presentation to users based on user navigation through streams of multimedia content, in accordance with one or more implementations.

FIG. 2 illustrates an implementation of a server employed in the system of FIG. 1.

FIG. 3 illustrates an online content resource graph that depicts nodes representing online streams of multimedia content and edges representing user navigation paths between the streams, in accordance with one or more implementations.

FIG. 4 illustrates an online content resource graph that depicts interim content associated with navigation paths, in accordance with one or more implementations.

FIG. 5 illustrates a method of dynamic content presentation to users based on user navigation through streams of multimedia content, in accordance with one or more implementations.

### DETAILED DESCRIPTION

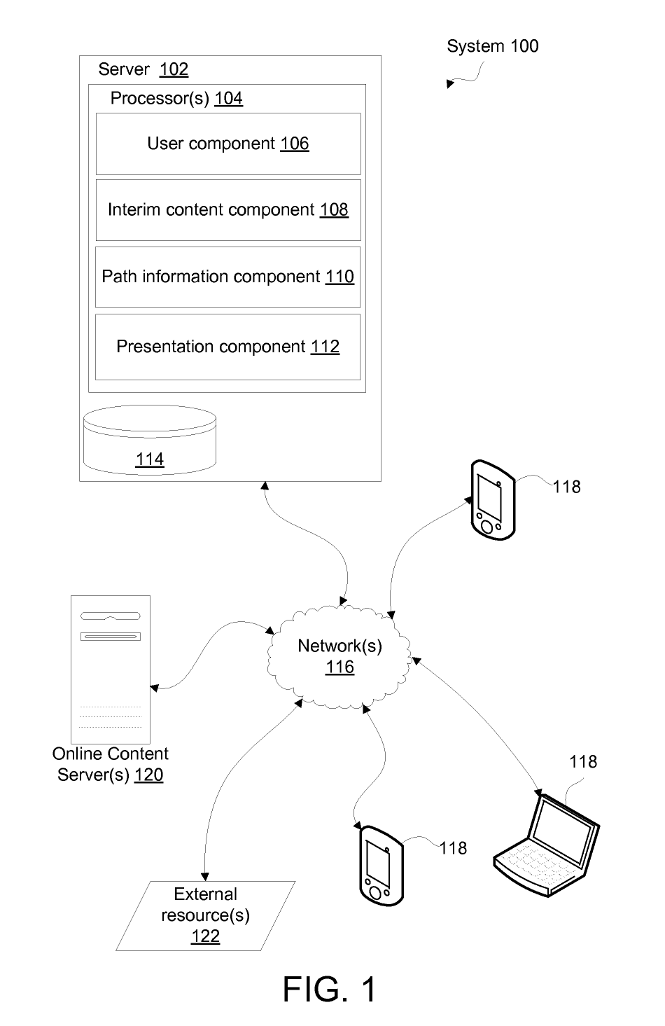

FIG. 1 illustrates a system 100 for dynamic content presentation to users based on user navigation through online content, in accordance with one or more implementations. The online content may include streams of multimedia content or other online content. The online content may be provided through a web page, website, and/or application accessible by users via client computing platforms 118 associated with the users. The online content may be hosted by a server, such as server 102, online content server(s) 120, a third-party host (e.g., via external resource 122), and/or other considerations. By way of non-limiting illustration, users may access online content by entering a URL into a web browser presented at an Internet-connected client computing platforms 118, launching an application, and/or other considerations. The online content may be served to the client computing platforms 118 through communications established between client computing platforms 118 and online content host.

Herein, the term “online content” may refer collectively to the streams of multimedia content and/or other content that may be accessible to users through one or more websites, web pages, applications, and/or other considerations. Users may interact with the online content by navigating between different available streams of multimedia content, and/or other considerations. Navigation may be facilitated by entry and/or selection by the users of content sources and/or locations that provide access to the content they wish to view. The entry and/or selection may generate requests to view, retrieve, and/or otherwise access the content (e.g., stream) from a host.

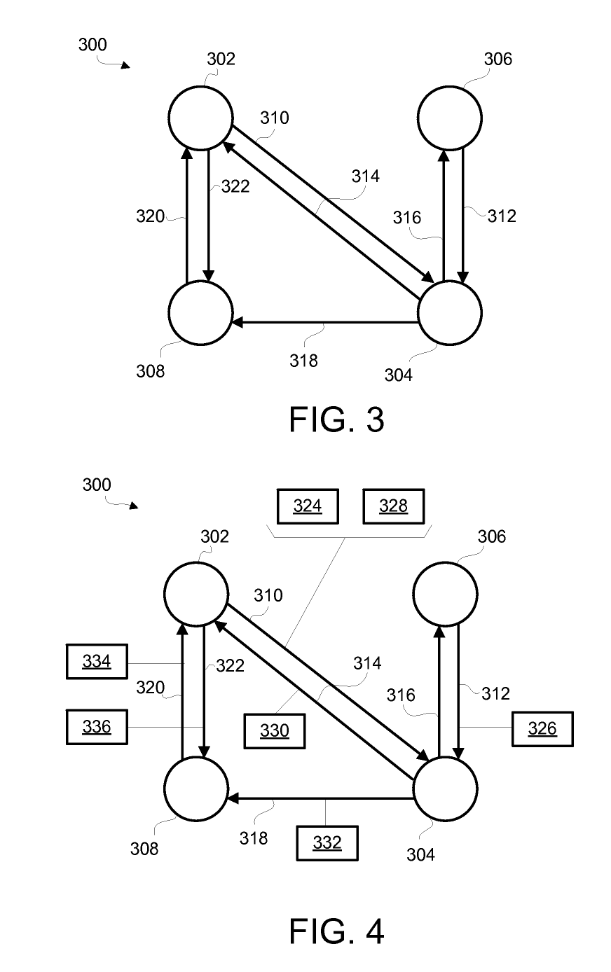

Referring now to FIG. 3, the online content available for access by the users may be represented by an online content resource graph 300. The resource graph 300 may include one or more nodes 302-308, one or more edges 310-322, and/or other features. The nodes 302-308 may represent different available streams of multimedia content or other content that may be accessible to the users. By way of non-limiting illustration, a node may represent one or more of a page, a tab, a destination, a feed, a stream, a resource, a location, a site, a link, and/or other source for content. Selections by users may generate requests to access the online content that may be transmitted to a content host. The content may then be served to a user at a client computing platform associated with the user. The edges 310-322 may connect between the nodes 302-308. The edges 310-322 may represent paths through which the users may navigate between the nodes 302-308. By way of non-limiting example, the ends of the edges 310-322 that include an arrow may represent an end node of which the user is requesting to navigate to. For example, a first edge 310 may correspond to a user accessing content associated with a first node 302 and then requesting access to content associated with a second node 304, and/or other considerations. That is, the first edge 310 may represent a user's navigation from the first node 302 to the second node 304, and/or other considerations. It is noted that the terms “edge” and “path” may be used interchangeably and may represent navigation paths. The terms “node” and “stream” or “stream of multimedia content” may be used interchangeably and may represent, in general, different online content that may be accessible to a user.

The depiction of the nodes 302-308 and edges 310-322 in FIG. 3 and FIG. 4 and the accompanying descriptions are not intended to be limiting. Instead, this is simply an example, and is not limiting with respect to content type, amount of content available to a user, navigation paths, and/or other characteristics of a web page, website, and/or application configured to present online content to users. For example, in some implementations, availability and/or accessibility of online content associated with a web page and/or website may include more or less content. The availability and accessibility of the online content may be represented by a resource graph that includes more or fewer nodes and/or edges, may be have edges that connect between nodes in different ways, and/or other considerations.

One or more implementations of the system 100 presented herein may facilitate a technique in which interim content may be presented to users based on the paths the users may take when navigating through online content. In terms of the resource graph in FIG. 3, navigation may be reflected by edges 310-322 a user follows when navigating between nodes 302-308. The interim content may comprise one or more of static content, interactive content, audio content, video content and/or other content. The interim content may comprise, for example, one or more of an advertisement, a poll, a video, an image, a game, and/or other considerations. The interim content may be different from the content associated with the content represented by the nodes, may be related to the content represented by the nodes, and/or other considerations.

FIG. 4 illustrates an implementation of the resource graph 300 depicting interim content 324-336 that may be associated with the different edges 310-322 (e.g., navigation paths), in accordance with one or more implementations presented herein. In some implementations, more than one instance of interim content may be associated with a signal edge, and/or other considerations. Individual ones of the interim content 324-336 may be presented to users based on a determination of their currently navigated paths. In implementations where more than one instance of interim content may be associated with a single path, at least one of the instances of interim content may be selected for presentation to the user. In some implementations, selection may be determined based on user information, preferences determined by a publisher and/or provider of the interim content, preferences determined by a provider, administration, and/or other entity associated with the online content, and/or other information. The user information may include user preferences, demographic profile information, content-viewing histories, and/or other information. The determination of content to present to users may be performed individually for each user, for a given group of users, and/or other considerations.

Returning to FIG. 1, server 102 may include one or more processors 104, electronic storage 114, and/or other components. The processor(s) 104 may be configured to execute one or more computer program components for facilitating dynamic content presentation to users based on user navigation through online streams of multimedia content. The computer program components may include one or more of a user component 106, an interim content component 108, a path information component 110, a presentation component 112, and/or other components.

The server 102 may be configured to communicate with one or more client computing platforms 118 over one or more networks 116, such as the Internet, and/or other considerations. The client computing platforms 118 and server 102 may communicate according to client/server architecture, and/or other considerations. The client computing platforms 118 may include, for example, a cellular telephone, a smartphone, a laptop, a tablet computer, a desktop computer, a television set-top box, smart TV, a gaming console, and/or other considerations.

In some implementations, the server 102 may be configured to host online content. For example, the server 102 may be an online content server, and/or other considerations. The users may access the online content hosted by the server via the client computing platforms 118. One or more components of server 102 may be configured to obtain information related to user browsing history, user preference, user navigation path information, web traffic information, and/or other information associated with user interaction with online content provided by server 102, and/or other considerations.

In some implementations, the users may access online content hosted by one or more online content servers 120, and/or other considerations. The online content server(s) 120 may be associated with one or more publishers and/or providers of online content, and/or other considerations. In some implementations, one or more computer components of server 102 may be configured to obtain information stored, managed, and/or otherwise associated with the online content server(s) 120. By way of non-limiting example, one or more computer components of server 102 may be configured to obtain information related to user browsing history, user preference, user navigation path information, demographic profile information, web traffic information, and/or other information associated with user interaction with online content provided by online content server(s) 120, and/or other considerations.

The user component 106 may be configured to access and/or manage one or more user profiles and/or user information associated with users of the system 100. The one or more user profiles and/or user information may include information managed by server 102, one or more of the client computing platforms 118, online content server(s) 120, and/or other locations. The user information may include, for example, information identifying users (e.g., a username or handle, a number, an identifier, and/or other identifying information), subscription information, usage information (e.g., browsing history, and/or other information), user preferences, demographic profile information, information stated by the users, a client computing platform identification associated with a user, a phone number associated with a user, and/or other information related to users.

Usage information may reflect a user's browsing history and/or other information associated with user access to online content. The usage information may be information collected, monitored, and/or managed by the server 102 (e.g., user component 106); information collected, monitored, and/or managed by online content server(s) 120 and obtained by the user component 106; information collected, monitored, and/or managed by the client computing platforms 118 and obtained by the user component 106, and/or other considerations. For example, usage information may be obtained from browser cookies and/or other information associated with user access to online content. The usage information may include information reflecting the websites visited by a user (e.g., frequency of visits, time between visits, and/or other considerations), the amount of time the user spent on a particular website (e.g., time spent viewing particular content, navigating through different content, and/or other considerations), information provided by a third party application, information related to user behavior such as what they click on, participation in poll/trivia questions, chatting or using other peer-to-peer communications, interactions with social media (e.g., sharing information, posting information, tweeting information, retweeting information, and/or other considerations), and/or other information.

User preferences may reflect information derived from user activity, information stated by the users, information obtained from an external source, and/or other information. User preferences derived from user activity may include information related to one or more most frequently visited websites, types of content most preferred by the user (e.g., types of streaming videos, live streams and/or feeds, music, sports, education, shopping, pictures, social content, blogs, and/or other considerations), types of items purchased by the user through online shops (e.g., clothing, electronics, books, gifts for others, men's apparel, women's appear, children's apparel, and/or other considerations), types of advertisements that the user tends to select the most, information collected from other sources (e.g., other user accounts, social media accounts, and/or other considerations), information provided by a third party resource (e.g., associated with a third party API running on the user's client computing platform, and/or other considerations), a social graph, other interests, and/or other information.

User preferences derived from information stated by the users may include information entered and/or selected by the user. This may include entry and/or selection of privacy preferences, favorite websites, personal preferences, associates (e.g., friends, colleagues, and/or other considerations), affiliations, currency preference, preferred payment method, and/or other information.

Demographic profile information associated with users may reflect information derived from user activity, information stated by the users, information obtained from an external source, and/or other information. Information included in the demographic profile may include gender, age, ethnicity, race, birthday, knowledge of languages, disabilities, mobility, home ownership, employment status, income level, real-world location, and/or other information. The demographic profile information may facilitate assigning the users to one or more particular demographic profiles. The demographic profiles may group one or more users into a predetermined user group that reflects commonalties of their demographic profile information, and/or other considerations. In some implementations, the demographic profiles and/or other information associated with the users may facilitate determining which interim content to present to the users.

In some implementations, the user component 106 may access and/or manage demographic profile information and/or other information corresponding to associates of a user. In some implementations, user associations may be facilitated by information included in user profiles including information stated by users (e.g., a “friends” and/or “followers” list generated by a user, and/or other considerations), information associated with a social media account of a user, and/or other considerations. In some implementations, the demographic profile information of a user's associates may facilitate pseudo-assigning the user to one or more demographic profiles. By way of non-limiting example, a user may be associated with a first demographic profile and not a second demographic profile. The user component 106 may be configured to determine that a threshold amount (e.g., based on quantity, percentage, and/or other considerations) of the user's associates are associated with the second demographic profile. The user component 106 may be configured to pseudo-assign the user to the second demographic profile. In some implementations, the pseudo-association to demographic profiles based on user associates may facilitate determining which interim content to present to a user.

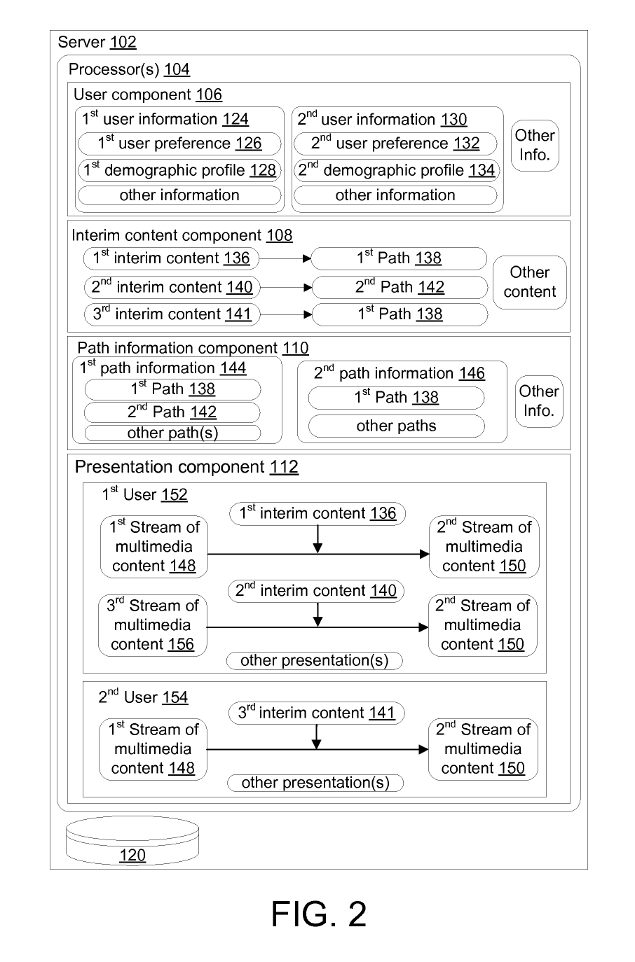

By way of illustration in FIG. 2, the user component 106 may be configured to manage first user information 124 associated with a first user 152, and/or other information. The first user information 124 may reflect one or more of a first user preference 126 of the first user 152, a first demographic profile 128 of the first user 152, and/or other information. The user component 106 may be configured to manage second user information 130 associated with a second user 154, and/or other information. The second user information 130 may reflect one or more of a second user preference 132 of the second user 154, a second demographic profile 134 of the second user 154, and/or other information.

Returning to FIG. 1, the interim content component 108 may be configured to obtain information related to interim content for presentation to users, associate interim content with paths, and/or perform more or fewer operations. Information related to interim content may be obtained from a provider or publisher of the interim content (e.g., third-party provider, and/or other considerations), a provider, administrator, and/or any other entity associated with the online content (e.g., a web page, website, and/or application provider), local storage of server 102 (e.g., electronic storage 114), online content sever(s) 120, and/or other considerations. Information related to interim content and/or other information may facilitate determining which interim content to present to a user.

The information related to the interim content may include one or more of the information that defines the interim content (e.g., source code), a source for accessing the interim content (e.g., a link, a network address, and/or other considerations), an identification of the interim content, a description of the interim content, a demographic profile associated with the content (e.g., specified by the interim content provider, and/or other considerations), a threshold amount of user associates that meet a demographic profile needed to facilitate pseudo-assigning a user to the demographic profile, payment information from a provider or publisher of the interim content, and/or other information.

An identification of the interim content and/or description of the interim content may be information provided by a publisher and/or provider of the interim content, a provider, administrator, and/or other entity associated with the online content, and/or other considerations. Identification of interim content may include one or more of a serial number, a code, a name, a key, and/or other information that may identify the interim content. A description of the interim content may include information that describes one or more aspects of the content, including, but not limited to, the content type (e.g., audio content, visual content, interactive content, an advertisement, a poll, and/or other considerations), what the content conveys (e.g., goods and/or services that may be offered, information to be displayed or spoken, and/or other considerations), age-appropriateness of the content, and/or other considerations. In some implementations, the identification and/or description of the interim content may convey an overview of the interim content.

In some implementations, the interim content may be associated with a demographic profile, and/or other information. The demographic profile may reflect an intended audience of the content and/or may be used to determine who the content should be presented to. The demographic profile of interim content may be provided based on information stated by the publisher and/or provider of the interim content, a provider, administrator, and/or other entity associated with the online content, and/or other considerations. By way of non-limiting example, a demographic profile associated with interim content may specify information such as “women, ages 18-34, who live on the west coast,” and/or other considerations.

In some implementations, interim content may be associated with a threshold amount of user associates meeting a given demographic profile in order to pseudo-assign a user to the demographic profile. The threshold amount may reflect an intended audience of the content being a particular user even if the particular user does not meet a given demographic profile associated with the content. By way of non-limiting example, interim content may be associated with a first threshold amount which may be intended for a first user and/or first group of users who may not meet a demographic profile associated with the interim content. By way of non-limiting example, information related with interim content may specify “show interim content A to users having 80% of their associates meeting demographic profile 1,” and/or other considerations.

It is noted that the above description of demographic profiles, threshold amounts, and/or other information related to interim content that may be used to determine which content to present to a user is not intended to be limiting. Instead, it is provided for illustrative purposes only and is not to be considered limiting with respect to determining which interim content to present to a user.

In some implementations, publishers and/or providers of interim content (e.g., advertisements) may purchase targeted “slots” associated with when their content may be presented to users as they navigate through the online content. In some implementations, the interim content component 108 may interact with a billing system (not shown) to facilitate receiving payment information from publishers and/or providers of interim content. Payment information may reflect the slots that have been paid for, and/or other considerations. The slots may represent, for example, the different paths through which the users may navigate between different streams of multimedia content, and/or other considerations. The pricing of the slots may reflect the user traffic that may be expected and/or anticipated for the particular path, and/or other considerations. For example, a first price of a first slot related to presenting interim content during navigation of a first path may be associated with first expected user traffic of the first path. By way of non-limiting illustration, a relatively high-traffic path may be associated with a relatively greater purchase price for a slot associated with that path. A relatively low-traffic path may be associated with a relatively lesser purchase price for a slot associated with hat path. The relativity of traffic may be determined by a threshold amount of users who may navigate the path, and/or other considerations. The traffic of a particular path may be determined based one or more of historical traffic associated with the path, expectations of traffic (e.g., based on the streams of multimedia content that define the path), popularity of the streams of multimedia content associated with the path, projections based on the number of users that are accessing the online content in general, and/or other considerations.

In some implementations, the slots may be purchasable at different pricing tiers. A tier may be associated with a priority that may be placed on the interim content within the particular slot. In some implementations, one or more different interim content may be associated with a single path. Different tier levels (e.g., highest to lowest) may be associated with a path. The different level tiers may represent a priority that may be placed on the associated interim content. Priority may correspond to a prioritized time (e.g., a time when the most amount of traffic may be expected may be of higher priority than a time when lesser traffic may be expected, and/or other considerations), a frequency at which the content may appear when users are navigating the associated path (e.g., interim content associated with a higher-prioritized tier may appear more frequently than lower-prioritized tier for the same path), and/or other considerations.

In some implementations, other factors affecting price of a slot and/or tier may be based on the type of content to be presented and/or the capabilities of the purchaser. By way of non-limiting example, slots which may feature static content (e.g., static images, non-static graphics with low processing costs, and/or other considerations) may be priced less than slots which may feature content which is interactive, includes video and/or audio, captures user information (e.g., email, social media account information, and/or other information), includes polls and/or trivia, and/or other considerations.

By way of non-limiting example, a website may provide users the ability to access different streams of multimedia content, and/or other content. The website may be associated with providing users access to live (or recorded) real-world concert footage, and/or other content. Different streams of multimedia content may correspond to footage from different performance stages and/or events that may be present at the real-world concert. The content provider may be able to anticipate user traffic to and/or from different streams based on, for example, real-world traffic by real-world participants at the real-world concert, the popularity of the artists, the concert lineup and/or schedule, interactive events surrounding the different performances (e.g., blogging, chatting, polling, online artist question-and-answer sessions, artist picture-in-picture streams, and/or other considerations), promotional offerings to users, and/or other considerations. For example, a high-level tier of a slot may be associated with a path between different streams of multimedia content that correspond to appearance of the most popular artists at the concert. As another example, if two popular artists are playing at different stages during back-to-back time slots, a high-level tier of a slot may correspond to the path that navigates the user from the stream of the first artist to the stream of the second artist and may additionally correspond to a time period between when the first artist's performance ends and the second artist's performance is scheduled to begin, and/or other considerations.

The above description of a billing system, tiers, and/or pricing is not intended to be limiting. Instead, this is simply an example, and is not limiting with respect to the sale, purchase, or distribution of “slots,” the association of the tiers to the slots, and/or the manner in which path traffic may be determined and/or estimated. For example, in some implementations, the pricing or price level determination of the slots and/or tiers, and/or other information may be of a system 100 administrator's choice and may not be limited by the descriptions provided herein.

The interim content component 108 may be configured to associate interim content with one or more paths. The association may be based on the obtained information related to the interim content, based on selections by the provider, administrator, and/or any other entity associated with the online content, random associations, and/or other considerations. For example, as presented above, the associations of the interim content to the paths may correspond to the tier and/or slot purchased by the interim content provider, and/or other considerations. In some implementations, the associations may be based on preference of the provider, administrator, and/or any other entity associated with the online content. Associations of interim content may be considered in other ways.

In some implementations, interim content may be related to online content and prioritized accordingly. By way of non-limiting example, online content may be associated with a particular theme, brand, person, company, artist, band, and/or considerations. In some implementations, interim content may also be associated with a same or similar theme, brand, person, company, artist, band, and/or considerations. In some implementations, interim content may be associated with a path and/or prioritized higher in a slot based on the online content associated with the path being related to the interim content. By way of non-limiting example, first interim content may be associated with a first path and/or prioritized higher in a slot of the first path based on the first interim content being related to one or both of the starting or ending content associated with the first path. Following the above non-limiting example of a website being associated with providing users access to live (or recorded) real-world concert footage, if two popular artists are playing at different stages during back-to-back time slots, a path that navigates the user from the stream of the first artist to the stream of the second artist and may be associated and/or prioritized with interim content that relates to one or both of the first artist and/or second artist, and/or other considerations.

As an illustrative example in FIG. 2, the interim content component 108 may be configured to obtain information related to first interim content 136, second interim content 140, third interim content 141, and/or other content. The interim content component 108 may be configured to associate the first interim content 136, the third interim content 141, and/or other content with a first path 138. The interim content component 108 may be configured to associate the second interim content 140 with a second path 142. In some implementations, the first interim content 136 and/or second interim content 140 may correspond with the first demographic profile 128, and/or other considerations. In some implementations, the third interim content 141 may correspond with the second demographic profile 134, and/or other considerations.

The first path 138 may reflect user navigation from a first stream of multimedia content 148 to a second stream of multimedia content 150 (see, e.g., the presentation component 112 in FIG. 2). The association of the first interim content 136 and/or third interim content 141 with the first path 138 may result in the first interim content 136 and/or third interim content 141 being presented to a user (via the presentation component 112) responsive to determining that the user is currently viewing the first stream of multimedia content 148 and requesting to view the second stream of multimedia content 150 (via the path information component 110), and/or other considerations. The determination of whether one or both of the first interim content 136, third interim content 141, and/or other content should be presented to a user navigating the first path 138 may be based on user information associated with the user (e.g., demographic profile and/or other information associated with the user) corresponding information associated with the content (e.g., demographic profile and/or other information associated with the interim content), and/or other considerations.

The second path 142 may reflect user navigation from a third stream of multimedia content 156 to the second stream of multimedia content 150 (see, e.g., the presentation component 112). For example, the second path 142 may represent a user currently viewing the third stream of multimedia content 156 and requesting to view the second stream of multimedia content 150, and/or other considerations.

By way of non-limiting illustration, the first path 138 may be represented by the first edge 310 of the resource graph 300 shown in FIG. 4. The first stream of multimedia content 148 (FIG. 2) may be represented by the first node 302 (FIG. 4), and/or other considerations. The second stream of multimedia content 150 (FIG. 2) may be represented by the second node 304 (FIG. 4), and/or other considerations. The association of the first interim content 136 and/or third interim content 141 with the first path 138 (FIG. 2) may be represented by the association of first and third interim content items 324 and 328, respectively, with the first edge 310 (FIG. 4), and/or other considerations.

The second path 142 (FIG. 2) may be represented by the second edge 312 of the resource graph 300 in FIG. 4. The third stream of multimedia content 156 (FIG. 2) may be represented by a third node 306 (FIG. 4), and/or other considerations. The association of the second interim content 140 with the second path 142 (FIG. 2) may be represented by the association of the second interim content item 326 with the second edge 312 (FIG. 4), and/or other considerations.

Returning to FIG. 1, the path information component 110 may be configured to obtain path information associated with the users. The path information may reflect the paths through which the users may be navigating between different streams of multimedia content and/or other online content. In some implementations, the path information may reflect the current, real-time, near real-time, and/or ongoing navigation by the users through the online content. In some implementations, the path information may reflect current streams of multimedia content being viewed by the users and/or the subsequent requests by the users to access different streams of multimedia content. For example, path information may reflect that a user may be currently viewing a first stream of multimedia content and requesting to view a second stream of multimedia content, and/or other considerations. A distinct path may be specifically associated with the navigation from a first stream to a second stream. That is, a different path may be defined and/or otherwise associated with navigation from a third stream (or other stream) to the second stream, and/or other considerations.

In some implementations, the path information component 110 may be configured to obtain path information for associates of a user. In some implementations, the path information of associates may reflect current streams of multimedia content being viewed by the associates of the users and/or subsequent requests by the users' associates to access different streams of multimedia content.

In some implementations, path information may be obtained from one or more online content server(s) 120, the client computing platforms 118 associated with the users, locally from server 102, and/or other considerations. For example, if the online content is provided to the users from server 102, the server 102 may locally obtain the path information based on monitoring and/or detecting user navigation between streams of multimedia content, and/or other considerations. In some implementations, if the online content is provided to the users from online content server(s) 120, the path information component 110 may obtain the path information from monitoring performed at the online content server(s) 120, and/or other considerations. In some implementations, user navigation activity may be monitored and/or detected at the client computing platforms 118. In such implementations, the path information component 110 may obtain the path information from the client computing platforms 118, and/or other considerations.

By way of illustration in FIG. 2, the path information component 110 may be configured to obtain first path information 144 associated with the first user 152, and/or other information. The first path information 144 may reflect the current, real-time, near real-time, and/or ongoing navigation by the first user 152 through the online content. In some implementations, the first path information 144 may reflect that the first user 152 may be currently navigating the first path 138, and/or other paths. For example, at a first point in time, the first path information 144 may reflect that the first user 152 may be currently viewing the first stream of multimedia content 148. The first path information 144 may reflect that the first user 152 subsequently requests to view the second stream of multimedia content 150 and is thereby navigating the first path 138, and/or other considerations.

In some implementations, the first path information 144 may reflect that the first user 152 may be currently navigating the second path 142, and/or other paths. For example, at a second point in time, the first path information 144 may reflect that the first user 152 may be currently viewing the third stream of multimedia content 156. The first path information 144 may reflect that the first user 152 subsequently requests to view the second stream of multimedia content 150 and is thereby navigating the second path 142, and/or other considerations.

In some implementations, the path information component 110 may be configured to obtain second path information 146 associated with the second user 154, and/or other information. The second path information 146 may reflect the current, real-time, near real-time, and/or ongoing navigation by the second user 154 through the online content. In some implementations, the second path information 146 may reflect that the second user 154 may be currently navigating the first path 138, and/or other paths. For example, at a first point in time, the second path information 146 may reflect that the second user 154 may be currently viewing the first stream of multimedia content 148. The second path information 146 may reflect that the second user 154 subsequently requests to view the second stream of multimedia content 150 and is thereby navigating the first path 138.

Returning to FIG. 1, the presentation component 112 may be configured to determine interim content to present to users. The determination may be based on the obtained path information (e.g., via path information component 110), the associations of interim content with paths (e.g., as determined by the interim content component 108), user information (e.g., via user component 106), information associated with the interim content (e.g., via interim content component 108), and/or other information. The presentation component 112 may be configured to effectuate presentation of the determined interim content to the appropriate users.

The presentation component 112 may be configured to determine interim content to present to users based on the obtained path information reflecting the currently navigated paths of the users, the associations of interim content with paths, user information associated with the users, information associated with the interim content, information associated with associates of the users, and/or other information. In some implementations, if a path is associated with a single interim content, the determination of the interim content to present to the user based the user's currently navigated path may simply be the individual interim content associated with that path.

In some implementations, if a path is associated with more than one interim content, the determination of interim content to present to a user may be based on user information associated with the user, information associated with the interim content, information associated with associates of the user, and/or other information. User information that may be considered for determining interim content to present to the users may include one or more of user preferences, demographic profile information of the users, demographic profiles of associates of a user, and/or other information. Information associated with the interim content that may be considered for determining interim content to present to the users may include a demographic profile associated with the content, threshold amounts for pseudo-assigning a user to a demographic profile associated with interim content, and/or other information. In some implementations, the determination of interim content to present to users may be based on determining a match between a demographic profile of a user and a demographic profile associated with the interim content, and/or other considerations. In some implementations, the determination of interim content to present to users may be based on determining a match between a user preference and a description of the interim content, and/or other considerations. In some implementations, interim content providers may be able to target interim content to specific users and/or user groups based on demographic profiles of the users, user preferences of the users, associates of the users, and/or other information. The determination of interim content to present to users may be considered in other ways.

Presentation of interim content may be effectuated in a variety of ways. In some implementations, the presentation component 112 may be configured to effectuate presentation by one or more of providing the interim content to the client computing platforms 118 associated with the users, providing the interim content to the online content host, and/or other considerations. The presentation of the interim content may be effectuated prior to the presentation of a requested stream of multimedia content associated with the user's current navigation.

In some implementations, the presentation component 112 may be configured to effectuate presentation of interim content by providing the content to the client computing platforms 118 associated with the users. Responsive to obtained path information reflecting a current navigation path of a user, the presentation component 112 may be configured to push the interim content associated with the path to the client computing platform 118 associated with the user. The push may cause the client computing platform 118 to present the interim content by way of pop-up window, notification, message, banner ad, insertion and/or overlay onto a feed and/or stream, and/or other considerations.

In some implementations, the presentation component 112 may be configured to effectuate presentation of interim content by providing the content to the online content host. Responsive to obtained path information reflecting a current navigation path of a user, the presentation component 112 may be configured to provide the interim content associated with the path to the online content host. The online content host may then push the interim content into one or more streams and/or feeds of multimedia content they are providing to the users. For example, the interim content may be pushed into the views of the stream and/or feed of multimedia content the user is currently viewing, and/or other considerations. In some implementations, the interim content may be pushed in to the views of the requested stream of multimedia content prior to the presented the second stream of multimedia content, and/or other considerations. In some implementations, the interim content may be presented by way of a pop-up window, notification, message, email, text message, banner ad, insertion and/or overlay, and/or other considerations.

As an illustrative example in FIG. 2, the presentation component 112 may be configured to determine that the first interim content 136 may be presented to the first user 152. In some implementations, the determination may be based on one or more of the first path information 144 reflecting that the first user 152 may be currently navigating the first path 138 (e.g., currently viewing the first stream of multimedia content 148 and requesting to view the second stream of multimedia content 150), the first interim content 136 corresponding to the first demographic profile 128, the first user information 124 indicating that the first user 152 matches the first demographic profile 128, and/or other information. The presentation component 112 may be configured to effectuate presentation of the first interim content 136 to the first user 152. The first interim content 136 may be presented prior to presentation of the second stream of multimedia content 150, and/or other considerations.

In some implementations, the presentation component 112 may be configured to determine that the second interim content 140 may be presented to the first user 152. In some implementations, the determination may be based on one or more of the first path information 144 reflecting that the first user 152 may be currently navigating the second path 142 (e.g., currently viewing the third stream of multimedia content 156 and requesting to view the second stream of multimedia content 150), the second path 142 being associated with only the second interim content 140, and/or other information. The presentation component 112 may be configured to effectuate presentation of the second interim content 140 to the first user 152. The second interim content 140 may be presented prior to presentation of the second stream of multimedia content 150, and/or other considerations.

In some implementations, the presentation component 112 may be configured to determine that the third interim content 141 may be presented to the second user 154. The determination may be based on one or more of the second path information 146 reflecting that the second user 154 may be currently navigating the first path 138 (e.g., currently viewing the first stream of multimedia content 148 and requesting to view the second stream of multimedia content 150), the third interim content 141 corresponding to the second demographic profile 134, the second user information 130 indicating that the second user 154 matches the second demographic profile 134, and/or other information. The presentation component 112 may be configured to effectuate presentation of the third interim content 141 to the second user 154. The third interim content 141 may be presented prior to presentation of the second stream of multimedia content 150, and/or other considerations.

The above description of interim content determination and/or presentation is not intended to be limiting. Instead, this is simply an example, and is not limiting with respect to how the interim content may be determined for presentation to users and/or how presentation of the interim content may be effectuated.

Returning to FIG. 1, the server 102, client computing platforms 118, online content server(s) 120, and/or external resources 122 may be operatively linked via one or more electronic communication links. For example, such electronic communication links may be established, at least in part, via a network 116 such as the Internet and/or other networks. It will be appreciated that this is not intended to be limiting and that the scope of this disclosure includes implementations in which server 102, client computing platforms 118, online content server(s) 120, and/or external resources 122 may be operatively linked via some other communication media.

The external resources 122 may include sources of information, hosts and/or providers of information outside of system 100, external entities participating with system 100, and/or other resources. In some implementations, some or all of the functionality attributed herein to external resource(s) 122 may be provided by resources included in system 100.

The server 102 may include electronic storage 114, one or more processors 104, and/or other components. The server 102 may include communication lines or ports to enable the exchange of information with a network and/or other computing platforms. Illustration of server 102 in FIG. 1 is not intended to be limiting. The server 102 may include a plurality of hardware, software, and/or firmware components operating together to provide the functionality attributed herein to server 102. For example, server 102 may be implemented by a cloud of computing platforms operating together as server 102.

Electronic storage 114 may comprise electronic storage media that electronically stores information. The electronic storage media of electronic storage 114 may include one or both of system storage that is provided integrally (i.e., substantially non-removable) with server 102 and/or removable storage that is removably connectable to server 102 via, for example, a port or a drive. A port may include a USB port, a FireWire port, and/or other port. A drive may include a disk drive and/or other drive. Electronic storage 114 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 114 may include one or more virtual storage resources (e.g., cloud storage, a virtual private network, and/or other virtual storage resources). Electronic storage 114 may store software algorithms, information determined by processor 104, information received from server 102, information received from client computing platforms 118, and/or other information that enables server 102 to function as described herein.

Processor(s) 104 is configured to provide information processing capabilities in server 102. As such, processor 104 may include one or more of a digital processor, an analog processor, a digital circuit designed to process information, an analog circuit designed to process information, a state machine, and/or other mechanisms for electronically processing information. Although processor 104 is shown in FIG. 1 as a single entity, this is for illustrative purposes only. In some implementations, processor 104 may include one or more processing units. These processing units may be physically located within the same device, or processor 104 may represent processing functionality of a plurality of devices operating in coordination. The processor 104 may be configured to execute components 106, 108, 110, and/or 112. Processor 104 may be configured to execute components 106, 108, 110, and/or 112 by software; hardware; firmware; some combination of software, hardware, and/or firmware; and/or other mechanisms for configuring processing capabilities on processor 104.

It should be appreciated that although components 106, 108, 110, and/or 112 are illustrated in FIG. 1 as being co-located within a single processing unit, in implementations in which processor 104 includes multiple processing units, one or more of components 106, 108, 110, and/or 112 may be located remotely from the other components. The description of the functionality provided by the different components 106, 108, 110, and/or 112 described above is for illustrative purposes and is not intended to be limiting, as any of components 106, 108, 110, and/or 112 may provide more or less functionality than is described. For example, one or more of components 106, 108, 110, and/or 112 may be eliminated, and some or all of its functionality may be provided by other ones of components 106, 108, 110, 112 and/or other components. As another example, processor 104 may be configured to execute one or more additional components that may perform some or all of the functionality attributed below to one of components 106, 108, 110, and/or 112.

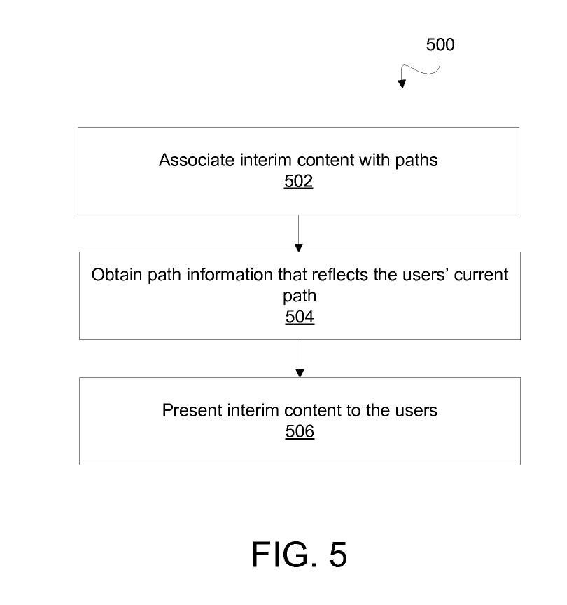

FIG. 5 illustrates a method 500 of dynamic content presentation to users based on user navigation through online streams of multimedia content. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At an operation 502, interim content may be associated with user navigation paths. The paths may correspond to user navigation between different streams of multimedia content, and/or other content. In some implementations, operation 502 may be performed by an interim content component the same as or similar to interim content component 108 (shown in FIG. 1 and described herein).

At an operation 504, path information that may reflect the paths through which the users may be navigating the streams of multimedia content may be obtained. In some implementations, operation 504 may be performed by a path information component the same as or similar to the path information component 110 (shown in FIG. 1 and described herein).

At an operation 506, presentation of the interim content to the users may be effectuated. The interim content to be presented may be determined based on the users' currently navigated paths, and/or other information. In some implementations, operation 506 may be performed by a presentation component the same as or similar to the presentation component 112 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system for dynamic content presentation to users based on user navigation through online streams of multimedia content, the system comprising:
one or more physical processors configured by computer-readable instructions to:
associate interim content with paths, the paths corresponding to user navigation between different streams of multimedia content, the interim content including first interim content associated with a first path, the first path corresponding to user navigation from a first stream of multimedia content to a second stream of multimedia content selected by the user, and wherein the first interim content is different from the second stream of multimedia content and is not selected by the user;
obtain path information that reflects the paths through which the users are navigating the streams of multimedia content, the obtained path information including first path information associated with a first user;
effectuate presentation of respective portions of interim content to respective users based on their current navigation paths, such that responsive to the first user currently viewing the first stream of multimedia content and requesting to view the second stream of multimedia content, the first path information reflects that the first user is currently navigating the first path such that presentation of the first interim content to the first user is effectuated, wherein the first interim content is presented prior to presentation of the second stream of multimedia content, such that the system specifically addresses problems that arise when online content providers operate their computer networked content platforms at large scales in delivering the interim content, separate from the first and second streams of multimedia content, on the basis of the path through which the users are navigating the streams of content in response to the user's interaction with the networked systems.

2. The system of claim 1, wherein the one or more physical processors are configured by computer-readable instructions to associate second interim content with a second path, the second path corresponding to user navigation from a third stream of multimedia content to the second stream of multimedia content, such that responsive to the first user currently viewing the third stream of multimedia content and requesting to view the second stream of multimedia content, the first path information reflects that the first user is currently navigating the second path such that presentation of the second interim content to the first user is effectuated, wherein the second interim content is presented prior to presentation of the second stream of multimedia content.

3. The system of claim 1, wherein the one or more physical processors are configured by computer-readable instructions such that the interim content comprises one or more of static content, interactive content, audio content, or video content.

4. The system of claim 1, wherein the one or more physical processors are configured by computer-readable instructions to obtain user information associated with the users, the user information reflecting demographic profiles of the users, the obtained user information include first user information associated with the first user that reflects a first demographic profile of the first user.

5. The system of claim 1, wherein the one or more physical processors are configured by computer-readable instructions such that the first interim content is selected for presentation to the first user by virtue a demographic profile associated with the interim content matching a demographic profile associated with the first user.

6. The system of claim 1, wherein the one or more physical processors are configured by computer-readable instructions to associate third interim content with the first path, the third interim content corresponding to a second demographic profile, such that responsive to obtaining second path information associated with a second user that reflects that the second user is currently navigating the first path, and by virtue of the second user matching the second demographic profile, the second interim content is presented to the second user and the first interim content is not presented to the second user.

7. The system of claim 1, wherein the one or more physical processors are configured by computer-readable instructions such that streams of multimedia content comprise live streams of multimedia content being served from a real-world location.

8. The system of claim 1, wherein the one or more physical processors are configured by computer-readable instructions such that the different streams of multimedia content are available through a website, webpage, and/or application accessible to the users via client computing platforms associated with the users.

9. A method of dynamic content presentation to users based on user navigation through online streams of multimedia content, the method being implemented in a computer system including one or more physical processors and storage media storing machine-readable instructions, the method comprising:
associating interim content with paths, the paths corresponding to user navigation between different streams of multimedia content, the interim content including first interim content associated with a first path, the first path corresponding to user navigation from a first stream of multimedia content to a second stream of multimedia content selected by the user, and wherein the first interim content is different from the second stream of multimedia content and is not selected by the user;
obtaining path information that reflects the paths through which the users are navigating the streams of multimedia content, the obtained path information including first path information associated with a first user;
effectuating presentation of respective portions of interim content to respective users based on their current navigation paths, such that responsive to the first user currently viewing the first stream of multimedia content and requesting to view the second stream of multimedia content, the first path information reflects that the first user is currently navigating the first path such that presentation of the first interim content to the first user is effectuated, wherein the first interim content is presented prior to presentation of the second stream of multimedia content, such that the system specifically addresses problems that arise when online content providers operate their computer networked content platforms at large scales in delivering the interim content, separate from the first and second streams of multimedia content, on the basis of the path through which the users are navigating the streams of content in response to the user's interaction with the networked systems.

10. The method of claim 9, further comprising associating second interim content with a second path, the second path corresponding to user navigation from a third stream of multimedia content to the second stream of multimedia content, such that responsive to the first user currently viewing the third stream of multimedia content and requesting to view the second stream of multimedia content, the first path information reflects that the first user is currently navigating the second path such that presentation of the second interim content to the first user is effectuated, wherein the second interim content is presented prior to presentation of the second stream of multimedia content.

11. The method of claim 9, wherein the interim content comprises one or more of static content, interactive content, audio content, or video content.

12. The method of claim 9, further comprising:
obtaining user information associated with the users, the user information reflecting demographic profiles of the users, the obtained user information include first user information associated with the first user that reflects a first demographic profile of the first user.

13. The method of claim 9, wherein the first interim content is selected for presentation to the first user by virtue a demographic profile associated with the interim content matching a demographic profile associated with the first user.

14. The method of claim 9, further comprising associating third interim content with the first path, the third interim content corresponding to a second demographic profile, such that responsive to obtaining second path information associated with a second user that reflects that the second user is currently navigating the first path, and by virtue of the second user matching the second demographic profile, the second interim content is presented to the second user and the first interim content is not presented to the second user.

15. The method of claim 9, wherein the streams of multimedia content comprise live streams of multimedia content being served from a real-world location.

16. The method of claim 9, wherein the different streams of multimedia content are available through a website, webpage, and/or application accessible to the users via client computing platforms associated with the users.
